(19) United States
(12) Patent Application Publication
(10) Pub. No.: US 2026/0126649 A1
(43) Pub. Date: May 7, 2026

(54) DISPLAY SYSTEM AND DISPLAY DEVICE

(71) Applicant: WUHAN CHINA STAR OPTOELECTRONICS TECHNOLOGY CO., LTD., Wuhan (CN)

(72) Inventors: Yinghui PAN, Wuhan (CN); Guiyang ZHANG, Wuhan (CN); Rui HE, Wuhan (CN); Fei AI, Wuhan (CN)

(73) Assignee: WUHAN CHINA STAR OPTOELECTRONICS TECHNOLOGY CO., LTD., Wuhan (CN)

(21) Appl. No.: 19/091,728

(22) Filed: Mar. 26, 2025

Related U.S. Application Data
(63) Continuation of application No. PCT/CN2024/132394, filed on Nov. 15, 2024.

(30) Foreign Application Priority Data
Nov. 4, 2024 (CN) 202411564448.6

(51) Int. Cl. G02B 27/01; G02F 1/1335; G02F 1/13357; G02F 1/1362

(52) U.S. Cl. CPC G02B 27/0101; G02F 1/133512; G02F 1/133602; G02F 1/136286; G02B 2027/0118

(57) ABSTRACT

A display system and a display device are disclosed in embodiments of the present application. The display system includes a display panel and a reflective assembly configured to receive an image source, project the image source to an eye, and form a virtual image. Data lines and scan lines in an array substrate of the display panel intersect to form opening areas, and sub-pixel openings are provided in a black matrix layer of a counter substrate of the display panel. In a top view of the display panel, a center of each of the opening areas is offset relative to a center of a corresponding one of the sub-pixel openings.

### CROSS-REFERENCE TO RELATED APPLICATIONS

This application is a continuation application of International Application No. PCT/CN2024/132394, filed on Nov. 15, 2024, which claims priority to Chinese patent application No. 202411564448.6, filed on Dec. 4, 2024, and the disclosures of which are incorporated herein by reference in their entireties.

### TECHNICAL FIELD

The present application relates to the field of display technologies, and in particular to a display system and a display device.

### BACKGROUND

Head-up display technologies focus on generating clear images to avoid distracting the drivers. The imaging quality is related to a chief ray angle (CRA) of an optical machine and a light pattern of a display screen.

In a conventional display screen in an optical machine system, the centers of openings of an array substrate and the centers of openings of a black matrix of a color filter substrate are overlapped in the thickness direction of the display screen. In this architecture, the display screen has the maximum luminance at the normal viewing angle and lower luminance at large viewing angles. Therefore, in order to adjust the imaging quality, the display screen needs to be tilted to match the CRA of the optical machine.

### SUMMARY

In an aspect, embodiments of the present application provide a display system, and the display system includes:
a display panel configured to output an image source; and
a reflective assembly configured to receive the image source, project the image source to an eye, and form a virtual image.

The display panel includes an array substrate and a counter substrate that are disposed opposite to each other, the array substrate includes data lines and scan lines intersecting to form a plurality of opening areas, the counter substrate includes a black matrix layer provided with a plurality of sub-pixel openings, and in a thickness direction of the display panel, the sub-pixel openings and the opening areas are in one-to-one correspondence to form light-exit channels.

In a top view of each of the light-exit channels of the display panel, a center of each of the opening areas is offset relative to a center of a corresponding one of the sub-pixel openings.

In another aspect, embodiments of the present application provide a display device including the display system described in the embodiments above.

### BRIEF DESCRIPTION OF THE DRAWINGS

FIG. 1 is a schematic diagram of a structure of a display system provided in embodiments of the present application;

FIG. 2 is a schematic diagram of a structure of a display panel of a display system in which a counter substrate is offset relative to an array substrate provided in embodiments of the present application;

FIG. 3 is another schematic diagram of a structure of a display panel of a display system in which a counter substrate is offset relative to an array substrate provided in embodiments of the present application;

FIG. 4A illustrates a light pattern of a display panel in the existing technologies;

FIG. 4B is a luminance attenuation curve corresponding to the display panel in FIG. 4A;

FIG. 5 illustrates light patterns of display panels of display systems in which counter substrates shift right relative to respective array substrates provided in embodiments of the present application;

FIG. 6 is a luminance attenuation curve corresponding to a display panel in which the counter substrate shifts right by 0.5 micrometers relative to a corresponding array substrate in FIG. 5;

FIG. 7 is a schematic diagram of a structure of an array substrate of a display panel of a display system provided in embodiments of the present application;

FIG. 8 is a schematic diagram of another structure of a display system provided in embodiments of the present application; and

FIG. 9 is a schematic diagram of a structure of a display device provided in embodiments of the present application.

### DETAILED DESCRIPTION

Technical proposals of embodiments of the present application will be described clearly and comprehensively below in conjunction with the accompanying drawings in the embodiments of the present application. It is obvious that the embodiments described are merely a part of embodiments of the present application, rather than all of them. All other embodiments that a person skilled in the art can obtain without creative effort based on the embodiments of the present application shall fall within the scope of protection of the present application. In addition, it will be understood that the specific embodiments described herein are only for the purpose of illustrating and explaining the present application and do not intended to limit the present application. In the present application, the embodiments can be combined with each other without further elaboration. Unless otherwise stated, directional terms such as “up” and “down” generally refer to the actual use or working state of the device, specifically corresponding to the orientation in the accompanying drawings; “inside” and “outside” are defined relative to the contour of the device; and terms such as “first”, “second” and “third” are used solely for identification purpose and do not impose numerical requirements or establish any order.

In an aspect, embodiments of the present application provide a display system, and the display system includes:
a display panel configured to output an image source; and
a reflective assembly configured to receive the image source, project the image source to an eye, and form a virtual image.

The display panel includes an array substrate and a counter substrate that are disposed opposite to each other, the array substrate includes data lines and scan lines intersecting to form a plurality of opening areas, the counter substrate includes a black matrix layer provided with a plurality of sub-pixel openings, and in a thickness direction of the display panel, the sub-pixel openings and the opening areas are in one-to-one correspondence to form light-exit channels.

In a top view of each of the light-exit channels of the display panel, a center of each of the opening areas is offset relative to a center of a corresponding one of the sub-pixel openings.

Optionally, in some embodiments of the present application, in the top view of each of the light-exit channels of the display panel, a ratio of a distance between the center of each of the opening areas and the center of the corresponding one of the sub-pixel openings to a width of the corresponding one of the sub-pixel openings in a first direction ranges from 1.4% to 5.6%.

Optionally, in some embodiments of the present application, in the thickness direction of the display panel, a portion of the data lines or a portion of the scan lines is located in the corresponding sub-pixel opening, and the black matrix layer shields a portion of a corresponding opening area.

Optionally, in some embodiments of the present application, the black matrix layer includes a plurality of first light-shielding portions extending along the first direction and a plurality of second light-shielding portions extending along a second direction, the first direction is parallel to an extension direction of the scan lines, the second direction is parallel to an extension direction of the data lines, and the plurality of first light-shielding portions and the plurality of second light-shielding portions intersect to form the plurality of sub-pixel openings.

The first light-shielding portions completely cover the scan lines, and in the first direction, at least one of the second light-shielding portions covers a portion of a corresponding one of the data lines, and the corresponding one of the sub-pixel openings exposes another portion of the corresponding one of the data lines.

Optionally, in some embodiments of the present application, the black matrix layer includes a plurality of first light-shielding portions extending along the first direction and a plurality of second light-shielding portions extending along a second direction, the first direction is parallel to an extension direction of the scan lines, the second direction is parallel to an extension direction of the data lines, and the plurality of first light-shielding portions and the plurality of second light-shielding portions intersect to form the plurality of sub-pixel openings.

In the second direction, at least one of the first light-shielding portions covers a portion of a corresponding one of the scan lines, the corresponding one of the sub-pixel openings exposes another portion of the corresponding one of the scan lines, and the second light-shielding portions completely cover the data lines.

Optionally, in some embodiments of the present application, the array substrate further includes pixel electrodes, each of the pixel electrodes is disposed in a corresponding one of the opening areas, and in a top view of the display panel, the black matrix layer covers a portion of the pixel electrodes in the first direction or the second direction.

Optionally, in some embodiments of the present application, the display system further includes a backlight module, the display panel is located on a light-exit side of the backlight module, and a plane in which the backlight module is located is parallel to a plane in which the display panel is located.

Optionally, in some embodiments of the present application, the display system further includes a backlight module, the display panel is located on a light-exit side of the backlight module, and a plane where the backlight module is located intersects a plane where the display panel is located.

Optionally, in some embodiments of the present application, an angle between the plane in which the backlight module is located and the plane in which the display panel is located ranges from 10 degrees to 40 degrees.

Optionally, in some embodiments of the present application, the reflective assembly includes a first reflector, a second reflector, and a transreflective component, the first reflector is configured to reflect the image source to the second reflector, the second reflector is configured to receive the image source reflected by the first reflector and project the image source onto the transreflective component, and the transreflective component is configured to reflect the image source to the eye to form the virtual image.

The display system has a main optical axis, in a side view of the display system, a virtual line connecting a center of the transreflective component and a center of the virtual image is collinear with the main optical axis, and a plane in which the display panel is located is parallel to the main optical axis.

Optionally, in some embodiments of the present application, reflective surfaces of the first reflector and the second reflector are curved surfaces, and the transreflective component includes a front windshield component of a vehicle.

In another aspect, embodiments of the present application provide a display apparatus including the display system as described in any one of the embodiments above.

In the display system and display device in the embodiments of the present application, the array substrate or the counter substrate of the display panel shifts, so that in the top view of each light-emitting channel of the display panel, the center of each of the opening areas is offset relative to the center of the corresponding sub-pixel opening. As a result, the light pattern of the display panel is improved and the luminance at large viewing angles is enhanced.

A display system and a display device are provided in embodiments of the present application and will be described in detail below. It will be noted that the order of description of the following embodiments does not limit the preferred order of the embodiments.

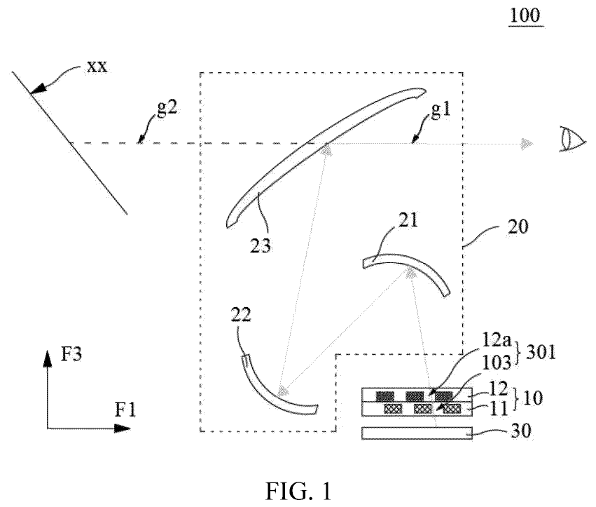

Referring to FIG. 1, the display system 100 is provided in embodiments of the present application, and the display system 100 includes a display panel 10 and a reflective assembly 20. The display panel 10 is configured to output an image source. The reflective assembly 20 is configured to receive the image source, project the image source to an eye of human, and form a virtual image xx.

The display system 100 further includes a backlight module 30 that provides an area light source for the display panel 10. The display panel 10 is located on the light-exit side of the backlight module 30. The plane where the backlight module 30 is located is parallel to the plane where the display panel 10 is located.

It will be understood that, the plane where the display panel 10 is located is the plane where the substrate of the display panel 10 is located, and the plane where the backlight module 30 is located is the plane where the back plate of the backlight module 30 is located. The plane where the backlight module 30 is located is parallel to the plane where the display panel 10 is located, which allows the backlight module 30 and the display panel 10 to be arranged at an equal distance, thereby saving assembly space.

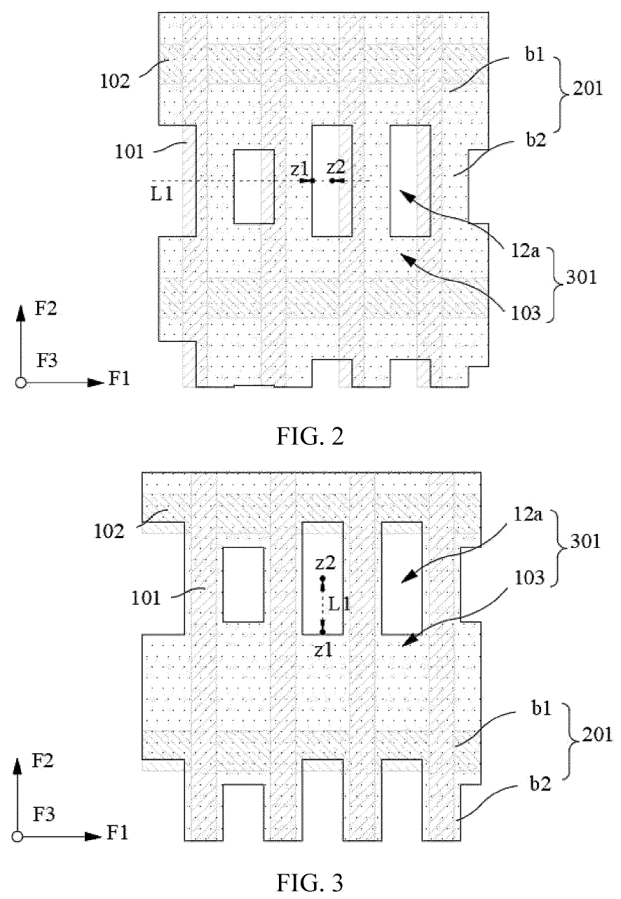

Optionally, referring to FIGS. 2 and 3, the display panel 10 of the display system 100 in some embodiments of the present application includes an array substrate 11 and a counter substrate 12 that are disposed opposite to each other. The array substrate 11 includes data lines 101 and scan lines 102, which intersect to form a plurality of opening areas 103. The counter substrate 12 includes a black matrix layer 201 provided with a plurality of sub-pixel openings 12a. In a thickness direction F3 of the display panel 10, each of the sub-pixel openings 12a and a corresponding one of the openings 103 are arranged correspondingly to form a light-exit channel 301.

In a top view of each light-exit channel 301 of the display panel 10, a center of each of the opening areas 103 is offset relative to a center of a corresponding sub-pixel opening 12a.

It will be noted that, as shown in FIG. 2, the offset between the center of the each of the opening areas 103 and the center of the corresponding sub-pixel opening 12a may be the counter substrate 12 shifting left or right relative to the array substrate 11 along a direction parallel to the scan lines 102. As shown in FIG. 3, the shift may also be the counter substrate 12 shifting up or down relative to the array substrate 11 along a direction parallel to the data lines 101. The shift may also be the counter substrate 12 shifting left or right, and then up or down relative to the array substrate 11. In some embodiments, the shift may also be the array substrate 11 shifting relative to the counter substrate 12.

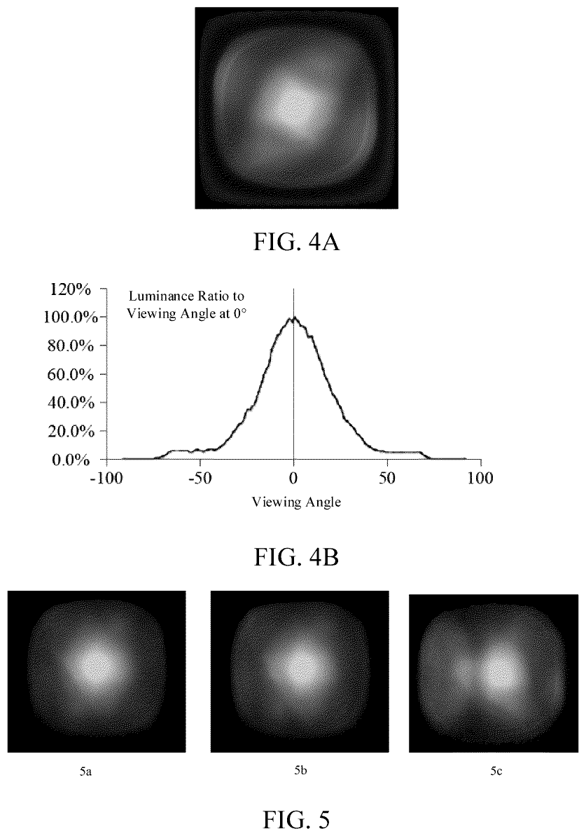

It should be understood that, in an existing display panel, the array substrate and the color filter substrate are disposed directly opposite to each other. That is, in the thickness direction of the display panel, the center of the opening area of the array substrate is directly opposite to the center of the sub-pixel opening of the black matrix of the color filter substrate, maximizing the luminance at the front viewing angle. However, when the existing display panel is applied to a display system including the optical machine, the imaging quality is related to the chief ray angle (CRA) of the optical machine and the light pattern of the display panel, in order to maximize the light exit effect, the fixed CRA of the optical machine and the light exit pattern (as shown in FIG. 4A) and the luminance attenuation curve (as shown in FIG. 4B) of the existing display panel indicate that the luminance at large viewing angles is relatively low, which is prone to color bias.

In the display system 100 in the embodiments of the present application, the array substrate 11 or the counter substrate 12 of the display panel 10 shifts, so that in the top view of each light-exit channel 301 of the display panel 10, the center of the opening area 103 is offset relative to the center of the corresponding sub-pixel opening 12a, thereby improving the light pattern of the display panel 10, widening the luminance attenuation curve, and enhancing the luminance at large viewing angles. As a result, the color bias is ameliorated.

Optionally, in some embodiments of the present application, in the top view of each light-exit channel 301 of the display panel 10, a ratio of a distance L1 between the center z1 of each of the opening areas 103 and the center 22 of the corresponding sub-pixel opening 12a to a width of the corresponding sub-pixel opening 12a in a first direction F1 is between 1.4% and 5.6%.

It can be understood that, the distance L1 between the center z1 of the opening area 103 and the center 22 of the corresponding sub-pixel opening 12a represents the relative offset between the opening area 103 and the corresponding sub-pixel opening 12a. The distance L1 is related to the size of the sub-pixel opening 12a. The larger the ratio of the distance L1 to the width of the corresponding sub-pixel opening 12a, the greater the relative offset between the opening area 103 and the corresponding sub-pixel opening 12a, and vice versa. The distance L1 between the center z1 of the opening area 103 and the center 22 of the corresponding sub-pixel opening 12a is the offset distance between the opening area 103 and the corresponding sub-pixel opening 12a. In a case where the distance L1 is too large, the light pattern of the display panel may be cut; and in a case where the distance L1 is too small, the effect of improving the luminance at large viewing angles is limited. Therefore, to ensure an improvement in the luminance at large viewing angles to effectively ameliorate the color bias, the ratio of the distance L1 between the center z1 of the opening area 103 and the center 22 of the corresponding sub-pixel opening 12a to the width of the corresponding sub-pixel opening 12a is set to be between 1.4% and 5.6%.

The ratio of the distance L1 between the center z1 of each of the opening areas 103 and the center 22 of the corresponding sub-pixel opening 12a to the width of the corresponding sub-pixel opening 12a may be 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, or 5.6%.

Optionally, in some embodiments, the distance L1 between the center z1 of the opening area 103 and the center z2 of the corresponding sub-pixel opening 12a is between 0.3 micrometers and 0.8 micrometers.

Optionally, the distance L1 between the center z1 of the opening area 103 and the center 22 of the corresponding sub-pixel opening 12a may be 0.3 micrometers, 0.4 micrometers, 0.5 micrometers, 0.6 micrometers, 0.7 micrometers, or 0.8 micrometers.

It will be noted that, the display panel 10 of the display system 100 in embodiments of the present application will be described with an example where the counter substrate 12 shifts right relative to the array substrate 11, to illustrate the corresponding light patterns.

Referring to FIG. 2, which illustrates a schematic view of the counter substrate 12 shifting right relative to the array substrate 11. The rightward shift of the counter substrate 12 causes the center z1 of the opening area 103 to be offset relative to the center z2 of the corresponding sub-pixel opening 12a, forming the offset distance L1.

Referring to FIG. 5, where part 5a shows the light pattern for the offset distance L1 ranging from 0.3 micrometers to 0.5 micrometers (including 0.5 micrometers), part 5b shows the light pattern for the offset distance L1 ranging from 0.5 micrometers to 0.8 micrometers (including 0.8 micrometers), and part 5c shows the light pattern for the offset distance L1 greater than 0.8 micrometers.

It can be seen from parts 5a and 5b in FIG. 5 that the luminance at large viewing angles of the display panel 10 is improved, and the luminance in the case of larger offset distance is better. It can be seen from part 5c in FIG. 5 that when the offset distance L1 is greater than 0.8 micrometers, the light pattern of the display panel 10 is cut.

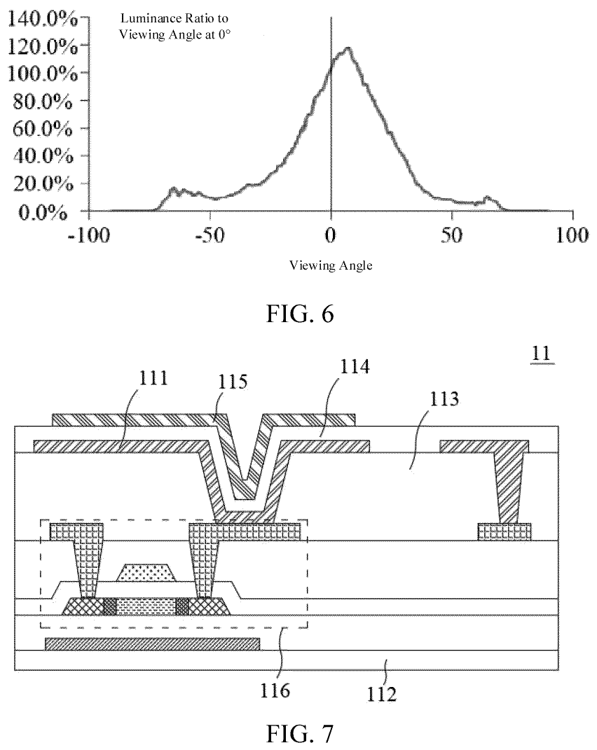

Referring to FIG. 6, which is the luminance attenuation curve corresponding to the light pattern of the display panel 10 when the offset distance L1 is equal to 0.5 micrometers. It can be seen from FIG. 6 that the CRA of the display panel 10 shifts right, and the luminance attenuation curve corresponding to FIG. 6 is wider than the existing luminance attenuation curve in FIG. 4B, with an increased utilization rate of light at large viewing angles.

Optionally, in some embodiments of the present application, in the thickness direction F3 of the display panel 10, a portion of the data lines 101 or a portion of the scan lines 102 is located in a corresponding sub-pixel opening 12a, and the black matrix layer 201 shields a portion of a corresponding one of the opening areas 103.

In FIGS. 2 and 3, the first direction F1 is parallel to the direction in which the scan lines 102 extend, and the second direction F2 is parallel to the direction in which the data lines 101 extend. Optionally, the first direction F1 is perpendicular to the second direction F2, and is not limited thereto. For example, the first direction F1 and the second direction F2 intersect non-perpendicularly.

In some embodiments, referring to FIG. 2, when the counter substrate 12 shifts left or right relative to the array substrate 11 along the first direction F1, a portion of a data line 101 is located in the corresponding sub-pixel opening 12a, and the black matrix layer 201 blocks a portion of the corresponding opening area 103.

The black matrix layer 201 includes a plurality of first light-shielding portions b1 and a plurality of second light-shielding portions b2. The first light-shielding portions b1 extend along the first direction F1, and the second light-shielding portions b2 extend along the second direction F2. The first light-shielding portions b1 and the second light-shielding portions b2 intersect to form the plurality of sub-pixel openings 12a.

The first light-shielding portions b1 completely cover the scan lines 102. In the first direction F1, each of the second light-shielding portions b2 covers a portion of a corresponding data line 101, and the sub-pixel opening 12a exposes another portion of the corresponding data line 101.

In some embodiments, referring to FIG. 3, when the counter substrate 12 shifts up or down relative to the array substrate 11 along the second direction F2, a portion of a scan line 102 is located in the corresponding sub-pixel opening 12a, and the black matrix layer 201 shields a portion of the corresponding opening area 103.

The difference of FIG. 3 from FIG. 2 is that FIG. 3 illustrates the counter substrate 12 shifting up or down, and thus in the second direction F2, each of the first light-shielding portions b1 covers a portion of a corresponding scan line 102, and the corresponding sub-pixel opening 12a exposes a portion of the corresponding scan line 102. The second light-shielding portions b2 completely cover the data lines 101.

Optionally, in some embodiments of the present application, the array substrate 11 further includes pixel electrodes 111, each of the pixel electrodes 111 is disposed in a corresponding opening area 103. In the top view of the display panel 10, the black matrix layer 201 covers a portion of the pixel electrodes 111 in the first direction F1 or the second direction.

It will be understood that, as the demand for luminance at large viewing angles increases, the offset distance L1 increases, causing the black matrix layer 201 to cover the portion of the pixel electrode 111.

Optionally, the driving architecture for liquid crystals in the display panel 10 may be based on the fringe field switching (FFS) technology driving architecture, or may be based on the in-plane switching (IPS) technology driving architecture, or may be based on the vertical alignment (VA) technology driving architecture, etc.

Referring to FIG. 7, which illustrates a schematic structural view of the array substrate 11 of the display panel 10. The array substrate 11 includes a base 112, a thin film transistor 116, a planarization layer 113, a passivation layer 114, and a common electrode 115. The thin film transistor 116 is disposed on the base 112, the planarization layer 113 covers the thin film transistor 116, the pixel electrode 111 is disposed on the planarization layer 113 and connected to thin film transistor 116. The passivation layer 114 covers the pixel electrode 111, and the common electrode 115 is disposed on the passivation layer 114.

It will be understood that the array substrate 11 of the display panel 10 may also be of other structure, which will not be described here.

In addition, it will be noted that, the color filter layer (not shown in the figures) may be formed on the counter substrate 12 or on the array substrate 11, which is not limited in the embodiments of the present application.

Optionally, with continued reference to FIG. 1, in some embodiments of the present application, the reflective assembly 20 includes a first reflector 21, a second reflector 22, and a reflective component 23. The first reflector 21 is configured to reflect the image source to the second reflector 22. The second reflector 22 is configured to receive the image source reflected by the first reflector 21 and project the image source onto the reflective component 23. The reflective component 23 is configured to reflect the image source to the human eye to form the virtual image XX.

The reflective component 23 can be a transreflective component. For example, when the display system 100 in the embodiments of the present application is applied to a vehicle, the reflective component 23 may include a front windshield component of the vehicle; and when the display system 100 in the embodiments of the present application is applied to the VR device, the reflective component 23 may include a viewport.

It will be noted that the specific architecture of the reflective assembly 20 is not limited to the embodiments above. For example, the reflective assembly 20 may include only one reflector, two reflectors, or more than three reflectors, etc.

Optionally, in some embodiments of the present application, reflective surfaces of the first reflector 21 and the second reflector 22 are both curved surfaces.

The design of the first reflector 21 and the second reflector 22 with curved surfaces forms a dual freeform aspheric off-axis three-reflective system, which can precisely control the position and angle of the virtual image, ensuring that drivers can conveniently obtain the required information at different distances. This system can provide virtual images at different distances, such as 10 meters, 7.5 meters, and 3.5 meters, with each of the virtual images corresponding to different visual needs.

Optionally, in some embodiments of the present application, the display system 100 has a main optical axis g1. In a side view of the display system 100 (as shown in FIG. 1), a virtual line g2 connecting a center of the reflective component 23 and a center of the virtual image xx is collinear with the main optical axis g1, and a plane where the display panel 10 is located is parallel to the main optical axis g1.

It will be noted that the main optical axis g1 is in the range of the light-exit angle of the display system 100 and coincides with the direction of the virtual line g2 connecting the center of the reflective component 23 and the center of the virtual image xx. When the human eye is located at the main optical axis g1, the human eye has the best viewing angle.

The plane where the display panel 10 is located is parallel to the main optical axis g1, which allows the display panel 10 to be horizontally arranged in a vehicle head-up display scenario without the need for tilting, thereby greatly reducing the installation difficulty while also reducing the installation space in the vertical direction.

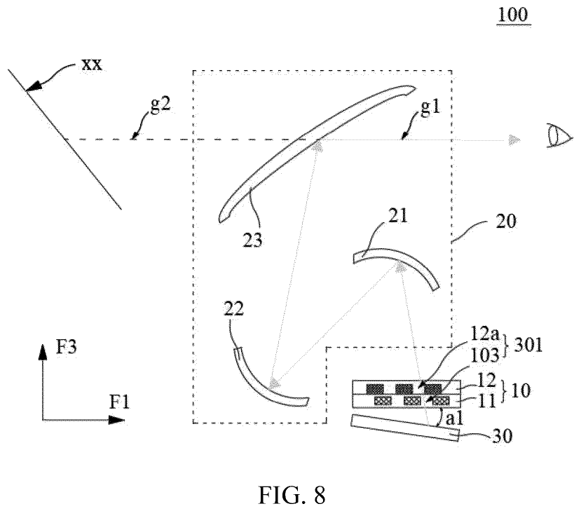

FIG. 8 illustrates the display system 100 in one or more embodiments of the present application. In FIG. 8, only parts that are different from the aforementioned embodiments will be described below to avoid redundancy.

Referring to FIG. 8, the plane where the backlight module 30 is located intersects the plane where the display panel 10 is located.

That is, compared with the display system 100 corresponding to FIG. 1, the embodiments corresponding to FIG. 8 adopts a backlight module 30 that is inclined relative to the display panel 10.

It will be understood that, the shift of the array substrate 11 or the counter substrate 12 of the display panel 10 increases the luminance at large viewing angles. Therefore, by tilting the backlight module 30, most of the light from the backlight module 30 can pass through the light-exit channels 301 of the display panel 10, enhancing the overall display luminance.

Optionally, in some embodiments of the present application, the angle a1 between the plane where the backlight module 30 is located and the plane where the display panel 10 is located ranges from 10 degrees to 40 degrees.

It will be understood that the larger the angle a1, the greater the inclination of the backlight module 30, and the larger the shift in the CRA of the backlight module 30. To match the CRA of the backlight module 30 with the light-exit channels 301 of the display panel 10 for a better light-exit effect, the angle a1 may be set to be between 10 degrees and 40 degrees, such as 10 degrees, 15 degrees, 20 degrees, 25 degrees, 30 degrees, 35 degrees, or 40 degrees.

It will be explained that, for the display system 100, the size of the angle a1 directly affects the light pattern of the display panel 10, and the inclined arrangement of the backlight module 30 is beneficial for optimizing the light pattern of the display panel 10 to match the CRA of the display system, resulting in better uniformity of the light entering the human eye.

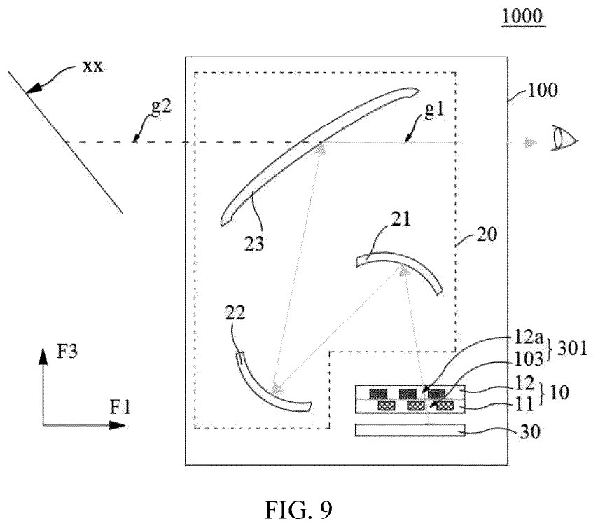

Referring to FIG. 9, embodiments of the present application provide a display device 1000 including the display system 100 as described in any one of the embodiments above.

It will be noted that, the structure of the display system 100 in the display device 1000 of embodiments of the present application is similar or identical to the structure of the display system 100 in any one of the embodiments above, and thus will not be repeated here.

Optionally, the display device 1000 may be a VR device or a vehicle-mounted display device, which is not limited thereto.

In the display device 1000 of the embodiments of the present application, the array substrate 11 or the counter substrate 12 of the display panel 10 of the display system 100 shifts, so that in the top view of each light-emitting channel 301 of the display panel 10, the center of the each of the opening areas 103 is offset relative to the center of the corresponding sub-pixel opening 12a. Thus, the light-exit angle of the display panel 10 is improved, ensuring that the light pattern of the display panel 10 matches the CRA required by the display device 1000. As a result, the light transmittance of the display device 1000 is improved, the color bias at large viewing angles is ameliorated, and high transmittance and high luminance are achieved in VR display.

The display system and the display device provided in the embodiments of the present application are described in details above. Specific examples are used herein to illustrate the principles and implementation methods of the present application. The descriptions of the above embodiments are only for the purpose of assist in understanding the methods and core ideas of the present application. Moreover, for those skilled in the art, there will be variations in the specific implementation methods and scope of application based on the concepts of the present application. In summary, the content of this specification should not be construed as a limitation on the present application.

What is claimed is:

1. A display system, comprising:
a display panel configured to output an image source; and
a reflective assembly configured to receive the image source, project the image source to an eye, and form a virtual image;
wherein the display panel comprises an array substrate and a counter substrate that are disposed opposite to each other, the array substrate comprises data lines and scan lines intersecting to form a plurality of opening areas, the counter substrate comprises a black matrix layer provided with a plurality of sub-pixel openings, and in a thickness direction of the display panel, the sub-pixel openings and the opening areas are in one-to-one correspondence to form light-exit channels;
in a top view of each of the light-exit channels of the display panel, a center of each of the opening areas is offset relative to a center of a corresponding one of the sub-pixel openings.

2. The display system according to claim 1, wherein in the top view of each of the light-exit channels of the display panel, a ratio of a distance between the center of each of the opening areas and the center of the corresponding one of the sub-pixel openings to a width of the corresponding one of the sub-pixel openings in a first direction ranges from 1.4% to 5.6%.

3. The display system according to claim 2, wherein in the thickness direction of the display panel, a portion of the data lines or a portion of the scan lines is located in the corresponding one of the sub-pixel openings, and the black matrix layer shields a portion of a corresponding one of the opening areas.

4. The display system according to claim 3, wherein the black matrix layer comprises a plurality of first light-shielding portions extending along the first direction and a plurality of second light-shielding portions extending along a second direction, the first direction is parallel to an extension direction of the scan lines, the second direction is parallel to an extension direction of the data lines, and the plurality of first light-shielding portions and the plurality of second light-shielding portions intersect to form the plurality of sub-pixel openings; and
the plurality of first light-shielding portions completely cover the scan lines, and in the first direction, at least one of the plurality of second light-shielding portions covers a portion of a corresponding one of the data lines, and the corresponding one of the sub-pixel openings exposes another portion of the corresponding one of the data lines.

5. The display system according to claim 3, wherein the black matrix layer comprises a plurality of first light-shielding portions extending along the first direction and a plurality of second light-shielding portions extending along a second direction, the first direction is parallel to an extension direction of the scan lines, the second direction is parallel to an extension direction of the data lines, and the plurality of first light-shielding portions and the plurality of second light-shielding portions intersect to form the plurality of sub-pixel openings; and
in the second direction, at least one of the plurality of first light-shielding portions covers a portion of a corresponding one of the scan lines, the corresponding one of the sub-pixel openings exposes another portion of the corresponding one of the scan lines, and the plurality of second light-shielding portions completely cover the data lines.

6. The display system according to claim 4, wherein the array substrate further comprises pixel electrodes, each of the pixel electrodes is disposed in the corresponding one of the opening areas, and in a top view of the display panel, the black matrix layer covers a portion of the pixel electrodes in the first direction or the second direction.

7. The display system according to claim 5, wherein the array substrate further comprises pixel electrodes, each of the pixel electrodes is disposed in the corresponding one of the opening areas, and in a top view of the display panel, the black matrix layer covers a portion of the pixel electrodes in the first direction or the second direction.

8. The display system according to claim 1, wherein the display system further comprises a backlight module, the display panel is located on a light-exit side of the backlight module, and a plane in which the backlight module is located is parallel to a plane in which the display panel is located.

9. The display system according to claim 1, wherein the display system further comprises a backlight module, the display panel is located on a light-exit side of the backlight module, and a plane where the backlight module is located intersects a plane where the display panel is located.

10. The display system according to claim 9, wherein an angle between the plane in which the backlight module is located and the plane in which the display panel is located ranges from 10 degrees to 40 degrees.

11. The display system according to claim 1, wherein the reflective assembly comprises a first reflector, a second reflector, and a transreflective component, the first reflector is configured to reflect the image source to the second reflector, the second reflector is configured to receive the image source reflected by the first reflector and project the image source onto the transreflective component, and the transreflective component is configured to reflect the image source to the eye to form the virtual image; and
the display system has a main optical axis, in a side view of the display system, a virtual line connecting a center of the transreflective component and a center of the virtual image is collinear with the main optical axis, and a plane in which the display panel is located is parallel to the main optical axis.

12. The display system according to claim 11, wherein reflective surfaces of the first reflector and the second reflector are curved surfaces, and the transreflective component comprises a front windshield component of a vehicle.

13. A display device, comprising a display system comprising:
a display panel configured to output an image source; and
a reflective assembly configured to receive the image source, project the image source to an eye, and form a virtual image;
wherein the display panel comprises an array substrate and a counter substrate that are disposed opposite to each other, the array substrate comprises data lines and scan lines intersecting to form a plurality of opening areas, the counter substrate comprises a black matrix layer provided with a plurality of sub-pixel openings, and in a thickness direction of the display panel, the sub-pixel openings and the opening areas are in one-to-one correspondence to form light-exit channels;
in a top view of each of the light-exit channels of the display panel, a center of each of the opening areas is offset relative to a center of a corresponding one of the sub-pixel openings.

14. The display device according to claim 13, wherein in the top view of each of the light-exit channels of the display panel, a ratio of a distance between the center of each of the opening areas and the center of the corresponding one of the sub-pixel openings to a width of the corresponding one of the sub-pixel openings in a first direction ranges from 1.4% to 5.6%.

15. The display device according to claim 14, wherein in the thickness direction of the display panel, a portion of the data lines or a portion of the scan lines is located in the corresponding one of the sub-pixel openings, and the black matrix layer shields a portion of a corresponding one of the opening areas.

16. The display device according to claim 15, wherein the black matrix layer comprises a plurality of first light-shielding portions extending along the first direction and a plurality of second light-shielding portions extending along a second direction, the first direction is parallel to an extension direction of the scan lines, the second direction is parallel to an extension direction of the data lines, and the plurality of first light-shielding portions and the plurality of second light-shielding portions intersect to form the plurality of sub-pixel openings; and
the plurality of first light-shielding portions completely cover the scan lines, and in the first direction, at least one of the plurality of second light-shielding portions covers a portion of a corresponding one of the data lines, and the corresponding one of the sub-pixel openings exposes another portion of the corresponding one of the data lines.

17. The display device according to claim 15, wherein the black matrix layer comprises a plurality of first light-shielding portions extending along the first direction and a plurality of second light-shielding portions extending along a second direction, the first direction is parallel to an extension direction of the scan lines, the second direction is parallel to an extension direction of the data lines, and the plurality of first light-shielding portions and the plurality of second light-shielding portions intersect to form the plurality of sub-pixel openings; and
in the second direction, at least one of the first light-shielding portions covers a portion of a corresponding one of the scan lines, the corresponding one of the sub-pixel openings exposes another portion of the corresponding one of the scan lines, and the plurality of second light-shielding portions completely cover the data lines.

18. The display device according to claim 16, wherein the array substrate further comprises pixel electrodes, each of the pixel electrodes is disposed in the corresponding one of the opening areas, and in a top view of the display panel, the black matrix layer covers a portion of the pixel electrodes in the first direction or the second direction.

19. The display device according to claim 13, wherein the display system further comprises a backlight module, the display panel is located on a light-exit side of the backlight module, and a plane where the backlight module is located is parallel to a plane where the display panel is located.

20. The display device according to claim 13, wherein the display system further comprises a backlight module, the display panel is located on a light-exit side of the backlight module, and a plane where the backlight module is located intersects a plane where the display panel is located.
